(19) United States
(12) Patent Application Publication
(10) Pub. No.: US 2009/0081441 A1
(43) Pub. Date: Mar. 26, 2009

(54) Fiber Tow Comprising Carbon-Nanotube-Infused Fibers

(75) Inventors: Tushar K. Shah, Columbia, MD (US); Mark R. Alberding, Glen Arm, MD (US); Harry C. Malecki, Middle River, MD (US)

Correspondence Address: Lockheed Martin c/o;DEMONT & BREYER, LLC, 100 COMMONS WAY, Ste. 250, HOLMDEL, NJ, 07733, US

(73) Assignee: LOCKHEED MARTIN CORPORATION, Bethesda, MD (US)

(21) Appl. No.: 12/235,317

(22) Filed: Sep. 22, 2008

Related U.S. Application Data
(60) Provisional application No. 60/973,968, filed on Sep. 20, 2007.
(60) Provisional application No. 60/973,969, filed on Sep. 20, 2007.

(51) Int. Cl. D03D 15/00; B29C 70/22

(52) U.S. Cl. 428/222; 156/166

(57) ABSTRACT

Fiber tows are formed by situating carbon-nanotube-infused filaments in close proximity to one another, enabling the nanotubes on the filaments to interdigitate. In some embodiment, this enables the formation of fiber tows that do not require do not require resin impregnation.

### STATEMENT OF RELATED CASES

This case claims priority of U.S. patent application Ser. No. 11/619,327 filed on Jan. 3, 2007 and U.S. Provisional Pat. Apps. Ser. No. 60/973,968 and Ser. No. 60/973,969, both filed on Sep. 20, 2007.

### FIELD OF THE INVENTION

The present invention relates to fiber-reinforced composite materials.

### BACKGROUND OF THE INVENTION

A composite material is a microscopic or macroscopic combination of two or more distinct materials with a recognizable interface between them. For structural applications, the definition can be restricted to include those materials that consist of a reinforcing phase, such as fibers or particles, which is supported by a binder or matrix phase.

A fiber-reinforced composite material typically includes a reinforcing fiber arranged in a random or ordered architecture and encapsulated in a matrix material, which is typically a polymer.

Fibers are the main source of strength of a fiber composite. The primary function of the fibers is to carry the loads along their longitudinal directions. Common fiber-reinforcing agents include Aluminum, Aluminum oxide, Aluminum silica, Asbestos, Beryllium, Beryllium carbide, Beryllium oxide, Carbon (Graphite), Glass (E-glass, S-glass, D-glass), Molybdenum, Polyamide (Aromatic polyamide, Aramid), e.g., Kevlar 29 and Kevlar 49, Polyester, Quartz (Fused silica), Steel, Tantalum, Titanium, Tungsten, and Tungsten monocarbide.

The matrix portion of the fiber composite binds fibers together by virtue of its cohesive and adhesive characteristics. The matrix maintains the orientation of the fibers, transfers load to and between fibers, and protects the fibers from mechanical and/or environmental damage. The matrix is the weak link in the composite; when the composite experiences loading, the matrix may crack, de-bond from the fiber surface, or break down under far lower strains than desired.

Most matrices are made of resins for their wide variation in properties and relatively low cost. Common resin materials include Epoxy, Phenolic, Polyester, Polyurethane, Vinyl Ester. Among these resin materials, polyesters are the most widely used. Epoxies, which have higher adhesion and less shrinkage than polyesters, are also more expensive. Although less commonly used than resins, non-resin matrices (mostly metals) can still be found in applications requiring higher performance at elevated temperatures, especially for the defense industry.

The composite material is formed by a multi-step process. A basic building block for the fiber reinforcement aspect of the process is the “fiber tow,” which comprises multiple individual filaments. Each tow can contain from several hundred to tens of thousands of individual filaments. Resin is then impregnated into the fiber reinforcement, which is referred to as tow pre-impregnation or “tow pre-preg” for short. Multiple tows are often woven into a fabric or coupled to create a unidirectional tape. Resin-treated fiber tow 100 is depicted in FIG. 1, and includes fiber filaments 102 and resin 104.

Before the fiber tow is woven, it is usually necessary to treat the reinforcement with a “sizing.” The sizing is a surface finish or coupling agent that enhances fiber-to-resin adhesion, eases processing (e.g., accommodates weaving processes), and protects the fibers from breakage. Sizing chemistry varies from manufacturer to manufacturer and can be optimized for specific manufacturing processes.

There are, however, disadvantages to this approach to forming fiber-reinforced composites. In particular, and among other disadvantages, the inter-laminar shear strength of the cured composite is limited by the strength of the fiber-resin interface. In fact, interlaminar shear failure is a common failure mode for composites.

There are two main approaches for addressing the issue of inter-laminar shear strength. One approach is to pre-treat or etch the fibers before they are impregnated with resin. This method is marginally effective in improving inter-laminar shear strength and does nothing to improve resin strength.

A second approach introduces bulk carbon nanotubes into the resin matrix. The randomly-arranged nanotubes in the resin matrix increase resin strength about 10 to 30 percent. This method, unfortunately, does not significantly improve fiber-to-resin adhesion.

### SUMMARY

The present invention provides fiber composites that avoid some of the drawbacks of the prior art. In accordance with the present invention, fiber tows are formed by situating carbon-nanotube-infused (“CNT-infused”) filaments in close proximity to one another, enabling the nanotubes on the filaments to “interdigitate.” In some embodiments, this enables the formation of fiber tows, tapes, and weaves that do not include a resin matrix. Fiber composites formed from such fiber tows exhibit increased interlaminar shear strength, tensile strength, and out-of-axis tensile strength.

It has been found that van der Waals forces between closely-situated groups of carbon nanotubes results in a dramatic increase in the interaction energies between the nanotubes. This causes the “interdigitation” of the carbon nanotubes, which results in what is, effectively, a filament-to-filament bond (e.g, adhesion, etc.). This filament-to-filament bond results in an increase in shear and tensile strength, relative to a filament-resin bond in a conventional fiber tow.

In some embodiments, pairs of filaments in a fiber tow are twisted into a helical arrangement. As a consequence, the fiber tow comprises a plurality of helically-twisted pairs of filaments. In each helical arrangement, carbon nanotubes that extend from one of filaments adhere, via van der Waals forces, to carbon nanotubes that extend from the other filament. In yet some further embodiments, more than two filaments are twisted to form a single helical arrangement, wherein carbon nanotubes from all filaments in the proximity of one another adhere.

The foregoing embodiments describe intra helix bonding between carbon nanotubes. That is, the bonding occurs between carbon nanotubes that are disposed on the filaments within a particular helical arrangement of filaments. Furthermore, inter helix bonding of carbon nanotubes also occurs. Inter helix bonding occurs between discrete helical arrangements. That is, the bonding occurs between carbon nanotubes on a filament in a first helical arrangement and carbon nanotubes on a filament in a second helical arrangement within a fiber tow.

The existence of intra helix carbon-nanotube bonding and, to a lesser extent, inter helix carbon-nanotube bonding, provides superior filament stabilization and load carrying ability. As a consequence of intra helix bonding, in some embodiments, a tow pre-preg (addition of resin to the fibers within the tow) is not required.

As a consequence of inter helix bonding, in some embodiments, resin is not added to couple adjacent tows to one another. Rather, to the extent that a plurality of fiber tows are weaved into multiple fabric layers, resin is used to couple the multiple layers of fabric to one another.

Since the strong attraction between fibers is on an intra and even inter tow basis, the resulting composites do not, in large part, exhibit the characteristic failure mechanisms of prior-art fiber composites.

### BRIEF DESCRIPTION OF THE DRAWINGS

FIG. 1 depicts a conventional fiber tow.

FIG. 2 depicts a fiber tow pre-preg in accordance with the present teachings, wherein the carbon nanotubes of nearby filaments adhere to one another.

FIG. 3 depicts a fiber tow in accordance with the illustrative embodiment of the present invention, wherein the carbon nanotubes of nearby filaments adhere to one another but no resin is used within the fiber tow.

FIG. 4 depicts a pair of filaments that are helically-twisted in accordance with the present teachings, wherein carbon nanotubes on the filaments adhere to one another.

FIG. 5 depicts an alternative embodiment of a fiber tow, wherein the fiber tow comprises helically-twisted filament pairs, wherein the carbon nanotubes on the filaments in the fiber tow exhibit both intra- and inter-helix bonding.

FIG. 6 depicts a fabric comprising a plurality of fiber tows in accordance with the present teachings, wherein resin is used inter-tow, but not intra-tow.

FIG. 7 depicts a weave comprising a plurality of fabric layers in accordance with the present teachings, wherein resin is used inter-fabric, but not intra-fabric.

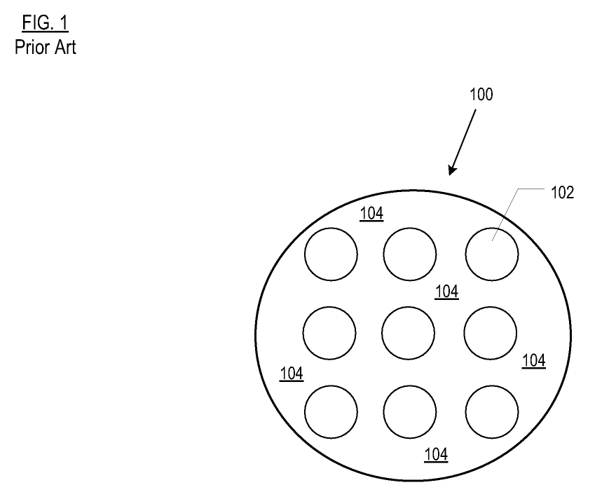

### DETAILED DESCRIPTION

The following terms are defined below for use in this disclosure and the appended claims.
“Fiber” is a unit of matter, either natural, or manufactured, which forms the basic element of fabrics and other textile structures.
“Filament” is a single fiber of an indefinite length, either natural or manufactured. For the purposes of this disclosure and the appended claims, the terms “fiber” and “filament” are synonymous.
“Infused” means physically or chemically bonded.
“Interdigitate” means an interlocking or interweaving of fingerlike projections (e.g., carbon nanotubes, etc.).
“Matrix” is the portion of a composite that binds the reinforcing phase.
“Resin” is a liquid polymer that, when catalyzed, cures to a solid state.
“Sizing” is a surface treatment that is applied to filaments immediately after their formation for the purpose of promoting good adhesion between those filaments and the matrix, to the extent the filaments are to be used as the reinforcing agent in a composite material.
“Tow” is group of filaments. In the prior art, the tow includes filaments and resin. In the illustrative embodiment of the present invention, the tow does not include resin.

CNT-Infused Filaments. In the fiber tows described herein, the carbon nanotubes are “infused” to the “parent” filament. In the present context, the term “infused” means physically or chemically bonded and “infusion” means the process of physically or chemically bonding. The physical bond between the carbon nanotubes and parent filament is believed to be due, at least in part, to van der Waals forces. The chemical bond between the carbon nanotubes and the parent filament is believed to be a covalent bond.

Regardless of its true nature, the bond that is formed between the carbon nanotubes and the parent filament is quite robust and is responsible for CNT-infused filament being able to exhibit or express carbon nanotube properties or characteristics. This is in stark contrast to some prior-art processes, wherein nanotubes are suspended/dispersed in a solvent solution and applied, by hand, to fiber. Because of the strong van der Waals attraction between the already-formed carbon nanotubes, it is extremely difficult to separate them to apply them directly to the fiber. As a consequence, the lumped nanotubes weakly adhere to the fiber and their characteristic nanotube properties are weakly expressed, if at all.

The infused carbon nanotubes effectively function as a replacement for conventional “sizing.” It has been found that infused carbon nanotubes are far more robust molecularly and from a physical properties perspective than conventional sizing materials. Furthermore, the infused carbon nanotubes improve the fiber-to-matrix interface in composite materials and, more generally, improve fiber-to-fiber interfaces. In fact, the CNT-infused filament is itself similar to a composite material in the sense that its properties will be a combination of those of the parent filament as well as those of the infused carbon nanotubes.

CNT-infused filaments are formed by synthesizing the carbon nanotubes in place on the parent filament itself. It is important that the carbon nanotubes are synthesized on the parent filament. If not, the carbon nanotubes will become highly entangled and infusion does not occur.

The parent filament can be any of a variety of different types of fibers, including, without limitation: carbon fiber, graphite fiber, metallic fiber (e.g., steel, aluminum, etc.), ceramic fiber, metallic-ceramic fiber, glass fiber, cellulosic fiber, aramid fiber.

Nanotubes are typically synthesized on the parent filament by applying or infusing a nanotube-forming catalyst, such as iron, nickel, cobalt, or a combination thereof, to the filament. The CNT-infusion process includes the operations of:

Removing sizing from the parent filament;

Applying nanotube-forming catalyst to the parent filament;

Heating the filament to nanotube-synthesis temperature; and

Spraying carbon plasma onto the catalyst-laden parent filament.

See, e.g., U.S. Publ. Pat. App. No. US 2004/0245088 and Ser. No. 11/619,327, both of which are incorporated herein by reference.

In some embodiments, the infused carbon nanotubes are single-wall nanotubes. In some other embodiments, the infused carbon nanotubes are multi-wall nanotubes. In some further embodiments, the infused carbon nanotubes are a combination of single-wall and multi-wall nanotubes. There are some differences in the characteristic properties of single-wall and multi-wall nanotubes that, for some end uses of the filament, dictate the synthesis of one or the other type of nanotube. For example, single-walled nanotubes can be excellent conductors of electricity while multi-walled nanotubes are not.

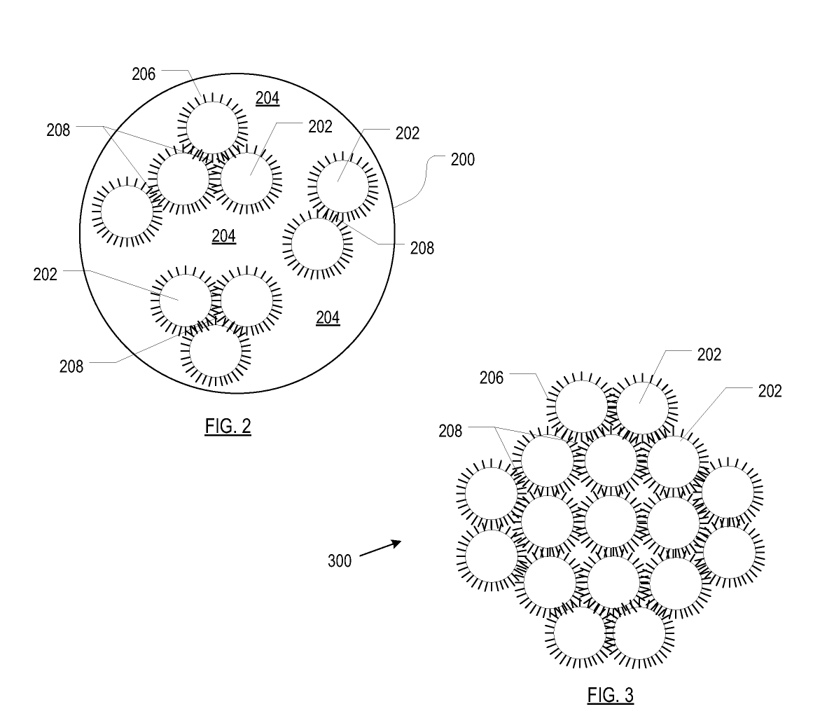

Fiber Tow Pre-Preg. FIG. 2 depicts fiber tow pre-preg 200 in accordance with the present teachings. Fiber tow pre-preg 200 includes groupings of CNT-infused filaments 202 in resin 204. Carbon nanotubes 206 depending from the surface of filaments 202 within a given grouping interdigitate, such as at region 208, with carbon nanotubes on adjacent filaments within the same grouping. Filaments that interdigitate will be within about 1 nanometer (nm) of each other. This promoted by placing the filaments under hydrostatic pressure and elevated temperature, such as via an autoclave.

Fiber Tow. FIG. 3 depicts fiber tow 300 in accordance with the illustrative embodiment of the present invention. Fiber tow 300 comprises a plurality of CNT-infused filaments 202 but no resin. The filaments adhere to one another via interdigitation of carbon nanotubes 206, such as at region 208. Since no resin is present, fiber tow 300 will typically include more filaments than a conventional fiber tow. Again, interdigitation is promoted via exposing filaments to pressure and elevated temperature.

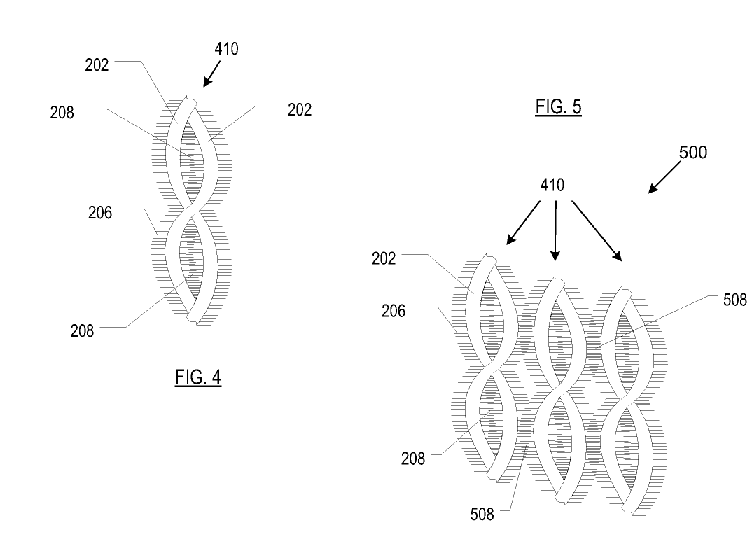

Helically-twisted filaments. FIG. 4 depicts helical arrangement 410. The helical arrangement comprises two CNT-infused filaments 202 that are twisted about one another into a helical shape. Carbon nanotubes 206 that depend from each filament interdigitate, such as at region 208, effectively creating a filament-to-filament bond. The helical twist can be imparted by revolving one of the processing spindles and pinching the tow at location, etc., as is known to those skilled in the art. The process of helically twisting the filaments is typically sufficient to place twisted filaments in intimate enough contact (i.e., within about 1 nm of each other) to promote interdigitation of the carbon nanotubes.

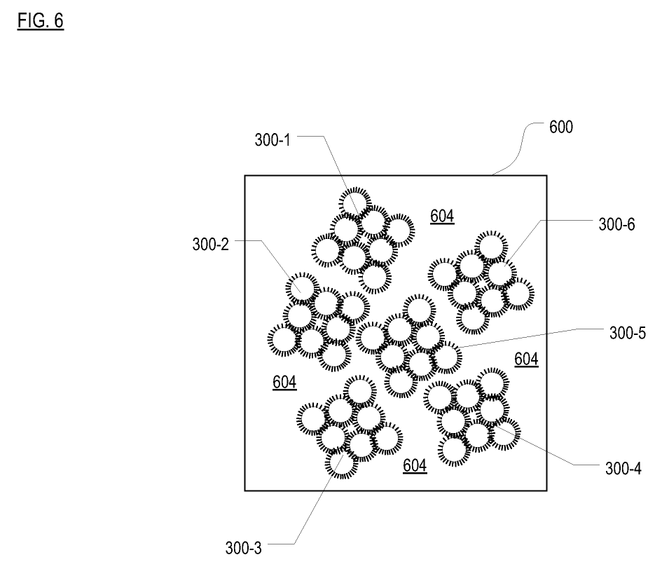

FIG. 5 depicts fiber tow 500 comprising a plurality of helical arrangements 410 of CNT-infused filaments 202, but no resin. Only three such arrangements are shown in the Figure; it is to be understood that tow 500, in reality, will typically include in excess of 6,000 such helical arrangements (with a minimum of two filaments per helical arrangement).

In addition to the interdigitation that occurs intra-helix, such as at region 208, interdigitation also occurs inter-helix, such as at regions 508. In other words, to the extent that carbon nanotubes on a filament in a first helical arrangement 410 are not already interdigitated with other carbon nanotubes on a second filament in the first helical arrangement, those available carbon nanotubes can interdigitate with carbon nanotubes from filaments in other helical arrangements. Inter-helix interdigitation is promoted via elevated pressure and temperature.

In some other embodiments, fiber tows that include helically-twisted CNT-infused filaments are impregnated with resin. Although such a tow is susceptible to the characteristic resin-induced failure mechanisms, the tow is expected to exhibit strength characteristics that are at least about twice that of a prior-art fiber tow pre preg. This is due to the additional strength imparted by the helically-twisted-CNT-infused groups of filaments.

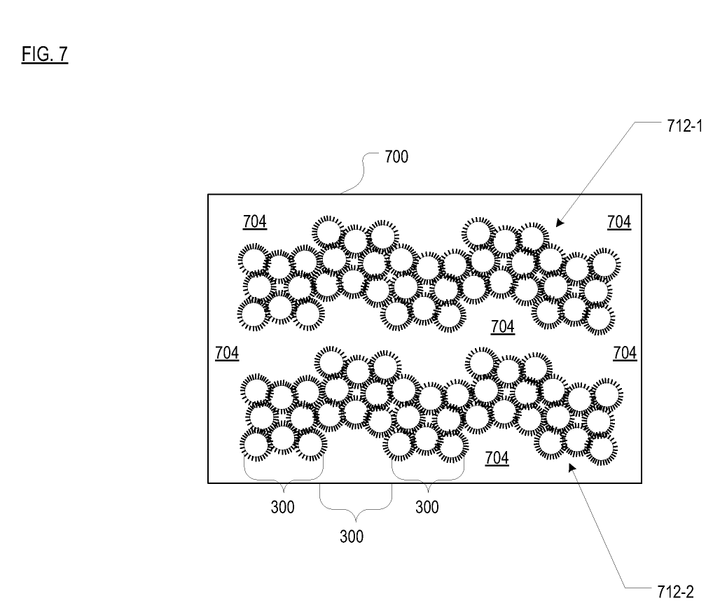

FIG. 6 depicts fabric 600 comprising a plurality of fiber tows 300-1 through 300-6 in resin 604. Each fiber tow 300-1 through 300-6 comprises a plurality of CNT-infused filaments, wherein the carbon nanotubes on neighboring filaments interdigitate with one another, as per the embodiment depicted in FIG. 3. In some other embodiments, at least some of the fiber tows comprise helically-twisted filaments, such as in fiber tow 500 depicted in FIG. 5. In other embodiments (not depicted), plural fiber tows can be interdigitated, in the manner described above, to form a ribbon or a tape.

FIG. 7 depicts weave 700 comprising a plurality of fabric layers (two layers 712-1 and 712-2 are shown) that are adhered with resin 704 in accordance with the present teachings. Each fabric layer 712-1 and 712-2 comprises a plurality of fiber tows 300 (or 500) that adhere to one another via carbon nanotube interdigitation. Each fiber tow comprises 300 (500) comprises a plurality of CNT-infused filaments, wherein the carbon nanotubes on neighboring filaments interdigitate with one another, as per the embodiment depicted in FIG. 3 or 5.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. An article comprising a fiber tow, wherein the fiber tow comprises a plurality of carbon-nanotube-infused filaments, and wherein the fiber tow is not impregnated with resin.

2. The article of claim 1 wherein adjacent filaments in the fiber tow are spaced apart from one another by a distance of less than about 1 nanometer.

3. The article of claim 1 further comprising a first plurality of fiber tows, wherein the first plurality of fiber tows collectively comprise a first fabric, and wherein the first fabric is not impregnated with resin.

4. The article of claim 3 further comprising:
a second fabric, wherein the second fabric comprises a second plurality of fiber tows that are woven together and wherein the second fabric is not impregnated with resin, and resin, wherein the resin couples the first fabric and the second fabric together.

5. The article of claim 1 further comprising a first plurality of fiber tows, wherein the first plurality of fiber tows collectively comprise a ribbon, and wherein the ribbon is not impregnated with resin.

6. The article of claim 1 further comprising a first plurality of fiber tows, wherein the first plurality of fiber tows collectively comprise a tape, and wherein the tape is not impregnated with resin.

7. The article of claim 1 wherein the fiber tow comprises a plurality of helical arrangements of carbon-nanotube-infused filaments, the helical arrangements exhibiting intra-helix bonding wherein carbon-nanotube-infused filaments within a helical arrangements interdigitate, and the helical arrangements further exhibit inter-helix bonding wherein carbon-nanotube-infused filaments within different helical arrangements interdigitate with one another.

8. The article of claim 7 further comprising a first plurality of fiber tows, wherein the first plurality of fiber tows collectively comprise a first fabric, and wherein the first fabric is not impregnated with resin.

9. The article of claim 8 further comprising:
a second fabric, wherein the second fabric comprises a second plurality of fiber tows that are woven together and wherein the second fabric is not impregnated with resin, and
resin, wherein the resin couples the first fabric and the second fabric together.

10. The article of claim 7 further comprising a first plurality of fiber tows, wherein the first plurality of fiber tows collectively comprise a ribbon, and wherein the ribbon is not impregnated with resin.

11. The article of claim 7 further comprising a first plurality of fiber tows, wherein the first plurality of fiber tows collectively comprise a tape, and wherein the tape is not impregnated with resin.

12. An article comprising a fiber tow, the fiber tow including a plurality of helical arrangements of carbon-nanotube-infused filaments, wherein, within each helical arrangement, two or more carbon-nanotube-infused filaments are helically twisted about each other, and wherein the fiber tow is not impregnated with resin.

13. The article of claim 12 further comprising a first plurality of fiber tows, wherein the first plurality of fiber tows collectively comprise a first fabric, and wherein the first fabric is not impregnated with resin.

14. The article of claim 13 further comprising:
a second fabric, wherein the second fabric comprises a second plurality of fiber tows that are woven together and wherein the second fabric is not impregnated with resin, and
resin, wherein the resin couples the first fabric and the second fabric together

15. The article of claim 13 further comprising a first plurality of fiber tows, wherein the first plurality of fiber tows collectively comprise a ribbon, and wherein the ribbon is not impregnated with resin.

16. The article of claim 13 further comprising a first plurality of fiber tows, wherein the first plurality of fiber tows collectively comprise a tape, and wherein the tape is not impregnated with resin.

17. An article comprising a fiber tow, wherein the fiber tow comprises a plurality of carbon-nanotube-infused filaments and resin.

18. The article of claim 17 wherein the fiber tow comprises a plurality of helical arrangements of carbon-nanotube-infused filaments, wherein, within each helical arrangement, two or more carbon-nanotube-infused filaments are helically twisted about each other.

19. The article of claim 18 further comprising a first plurality of fiber tows, wherein the first plurality of fiber tows collectively comprise a first fabric.

20. The article of claim 19 further comprising:
a second fabric, wherein the second fabric comprises a second plurality of fiber tows including a plurality of helical arrangements of carbon-nanotube-infused filaments, wherein the first fabric and the second fabric are woven together; and
resin, wherein the resin couples the first fabric and the second fabric together.

21. A method for forming a first fiber tow, comprising:
forming a plurality of carbon-nanotube-infused fibers;
forming sub groupings of at least two of the fibers;
twisting the fibers within each sub grouping to form a plurality of helical arrangements.

22. The method of claim 21 further comprising impregnating the first fiber tow with resin.

23. The method of claim 21 further comprising subjecting the helical arrangements to elevated pressure.
